(19) United States
(12) Patent Application Publication
(10) Pub. No.: US 2002/0186178 A1
(43) Pub. Date: Dec. 12, 2002

(54) Optical observation apparatus provided with a system delivering information visually perceptible in the observation beam path

(76) Inventors: Tobias Kaufhold, Jena (DE); Johannes Knoblich, Jena (DE); Matthias John, Kleinpuerschuetz (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/030,838

(22) PCT Filed: May 5, 2001
(86) PCT No.: PCT/EP01/05081

(30) Foreign Application Priority Data
May 18, 2000 (DE) 100 24 686.9

(51) Int. Cl. G09G 5/00

(52) U.S. Cl. 345/7

(57) ABSTRACT

An optical observation instrument, particularly a microscope, is outfitted with at least one eyepiece in which a device for displaying information in a visually perceptible manner is arranged in the intermediate image plane. In this way, added information is effectively introduced into the observation beam path with low expenditure on instrumentation because, in contrast to the prior art, no splitter mirrors or the like optical components are required. Further, this prevents unnecessary attenuation of the intensity of the observed image due to additional splitter mirrors or the like.

The invention is directed to an observation instrument provided with a device for introducing visually perceptible information which preferably relates to the adjusted instrument parameters, the current operating states and/or the object to be observed.

The insertion of illuminated specimen data and reflection of other visually perceptible information into the beam path of optical observation instruments is known, above all, in microscopy, and plays an important part particularly in the production of microscope photographs. This is achieved, for example, in that nine-digit LED numbers are imaged in the film plane at the edge of the format.

In the arrangements that were previously developed for this purpose, the displayed information and data are reflected into the beam path at a suitable location by splitter mirrors or the like devices and made visible for the observer within the image field or, for a camera, within the film plane.

In optical observation instruments, particularly microscopes, to which image processing systems are connected, the data and information are revealed in the monitor image by means of computer software.

In camcorders, for instance, added information is made visible in the eyepiece in that corresponding data are generated on an LCD matrix by software. This added information and the structure of a recorded image which is made visible on the LCD matrix are reflected into the observation beam path together and can be viewed by means of the eyepiece optics or a magnifier. In other words, the image information and the added information are reproduced by means of a common display element, the LCD matrix. In so doing, the image resolution is limited by the size of the individual LCD pixels.

Proceeding from this prior art, it is the object of the invention to reflect data into the observation beam path of an optical observation instrument in a more economical manner.

To this end, at least one eyepiece is provided, according to the invention, in an optical observation instrument, and a device for displaying information in a visually perceptible manner is arranged in the intermediate image plane of the eyepiece. In this way, added information is effectively introduced into the observation beam path with low expenditure on instrumentation because, in contrast to the prior art, no splitter mirrors or the like optical components are required. Further, this prevents unnecessary attenuation of the intensity of the observed image due to additional splitter mirrors or the like.

The arrangement according to the invention results in the advantage that the observer can perceive additional information, e.g., about adjusted instrument parameters, about the operating state of the instrument and/or about the specimen, without having to interrupt observation through the eyepiece. Observation can be carried out without interrupting concentration.

In preferred embodiments of the invention, a self-illuminating LED display on which information is generated and which is connected to control electronics or an LCD display with background illumination on which information is generated and which is connected to control electronics is arranged in the intermediate image plane of the eyepiece.

Further, in a particularly preferred construction, not only the LCD display or LED display, but also the control electronics are integrated in the eyepiece tube and are connected by control lines and supply lines to a central operating device and supply device of the instrument. This results in a further simplification and compactness of the construction.

Further, according to the invention, the display of information is carried out outside the image field area reserved for observation. In this way, a negative influence on the good optical image quality customarily achieved with eyepiece observation is prevented, i.e., image quality is maintained while providing additional information for the observer.

The invention is further directed to an eyepiece as an independent component for retrofitting optical instruments, particularly for microscopes, in which a device for visually perceptible display of information according to the preceding description is provided in the intermediate image plane, this eyepiece being constructed with respect to shape, size and fastening means in the same manner as eyepieces not having such a device.

In this way, an optical component is provided by which the described advantages can also be exploited for microscopes or other optical observation instruments by replacing the previously used eyepieces with the eyepiece according to the invention.

For this purpose, the eyepiece can be provided with fastening elements adapted to the holder of the previously used eyepiece in the respective optical instrument so as to facilitate exchange. The control and power supply can be carried out via a standardized interface, e.g., an RS232 interface, to a central operating and supply device of the optical instrument.

In the following, the invention will be explained in more detail with reference to an embodiment example. In the accompanying drawing:

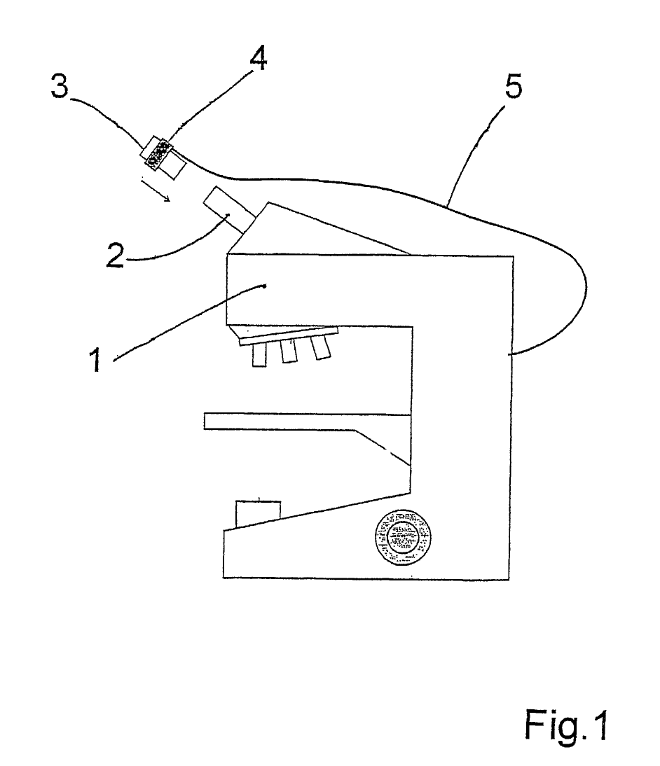

FIG. 1 shows a schematic view of a microscope which is outfitted with the eyepiece according to the invention;

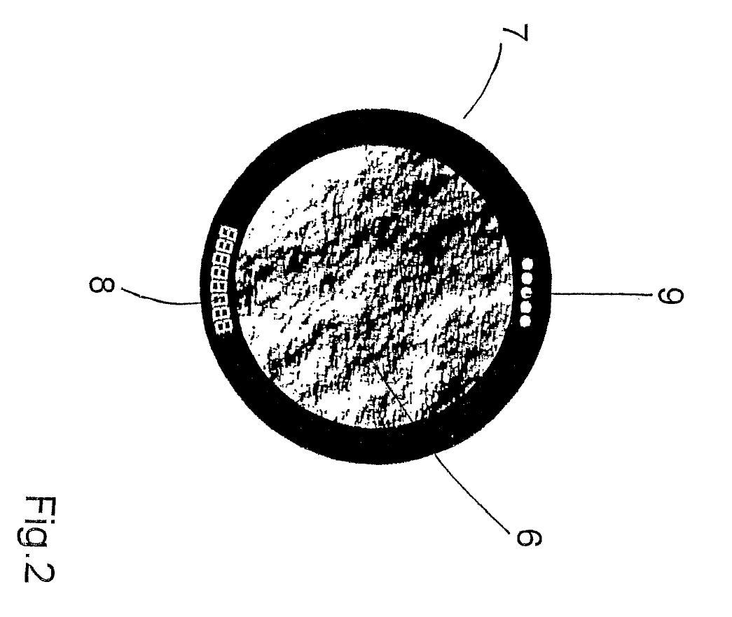

FIG. 2 shows an example for the arrangement of an eight-digit display and another five LED points outside the image within the viewing field border of the intermediate image plane of an eyepiece.

FIG. 1 shows a microscope construction 1 with an eyepiece tube 2. An eyepiece 3 which is outfitted, according to the invention, with a device 4 for superimposing information in the microscope beam path, e.g., a controllable self-illuminating LED display, is inserted in the eyepiece tube 2.

The eyepiece constructed in this way is connected, via a control and supply line 5, to the central operating and supply device of the microscope (not shown in the drawing). The device 4 is coupled with control electronics which, like the device 4, can either be integrated in the eyepiece 3 or, alternatively, can be located in the operating and supply device of the microscope.

The device 4 is positioned in the intermediate image plane of the eyepiece 3 in such a way that the display of information is carried out outside the image field area reserved for observation in the microscope beam path.

In a particularly preferred manner, the device 4 is positioned in the intermediate image plane in such a way that observation in the eyepiece 3 results in a view shown in FIG. 2. In this case, a specimen section 6 can be seen in the center of the image field area of the microscope beam path 7 with the customarily good image quality of typical eyepiece observation. An eight-digit display device 8 and another display device comprising five LED points which is located diametrically across from it are provided at the periphery. The display devices 8 and 9 are accordingly positioned outside of the intermediate image viewing field edge and do not negatively influence observation of the specimen section 6.

In particular, current parameter settings of the microscope such as magnification and working distance, measurement values such as focus position or intensity, operating states of the observation instrument such as switched on filter positions, switched on light sources, utilized optical beam path and the like can be displayed with the display devices 8 and 9.

List of Reference Numbers

| | |
|---|---|
| 1 | microscope construction |
| 2 | eyepiece tube |
| 3 | eyepiece |
| 4 | device |
| 5 | control and supply line |
| 6 | specimen section |
| 7 | microscope beam path |
| 8 | display device |
| 9 | display device |

1. Optical observation instrument with at least one eyepiece in which a device for displaying information preferably relating to the adjusted instrument parameters, the current operating state and/or the object to be observed in a visually perceptible manner is arranged in the intermediate image plane.

2. Optical observation instrument according to claim 1, characterized in that a self-illuminating LED display which is connected to control electronics or an LCD display with background illumination which is connected to control electronics is provided in the intermediate image plane of the eyepiece.

3. Optical observation instrument according to claim 1 or 2, characterized in that the control electronics are integrated in the eyepiece tube and are connected by control lines and supply lines to a central operating device and supply device of the observation instrument.

4. Optical observation instrument according to one of the preceding claims, characterized in that the information for the observer is perceptible in the eyepiece outside the image field area reserved for observation of the specimen.

5. Eyepiece for optical observation instruments with a device arranged in the intermediate image plane for displaying information in a visually perceptible manner, according to one of the preceding claims, which is constructed with respect to shape, size and fastening means in the same manner as an eyepiece not having such a device, so that an eyepiece with or without such a device can be exchanged on optical observation instruments.
